(19) United States
(12) Patent Application Publication
(10) Pub. No.: US 2003/0132678 A1
(43) Pub. Date: Jul. 17, 2003

(54) Sintered oilless bearing and motor using the same

(75) Inventor: Ki Hoon Park, Seoul (KR)

Correspondence Address: DARBY & DARBY P.C., 805 Third Avenue, New York, NY, 10022, US

(73) Assignee: Samsung Electro-Mechanics Co., Ltd.

(21) Appl. No.: 10/375,822

(22) Filed: Feb. 27, 2003

Related U.S. Application Data
(63) Continuation-in-part of application No. 09/698,352, filed on Oct. 27, 2000, now abandoned.

(30) Foreign Application Priority Data
Mar. 10, 2000 (KR) 2000-11939

(51) Int. Cl. H02K 5/16; H02K 7/08

(52) U.S. Cl. 310/90; 384/279

(57) ABSTRACT

A sintered oilless bearing and a capstan motor using the same includes first and second bearings inserted into an inside surface of a bearing holder and spaced-apart from each other within the bearing holder, and non-porous and porous parts formed on corresponding ones of the first and second bearings. The non-porous parts have an angle between 91° and 120° with respect to a center line of the first and second bearings, are disposed to face each other, or are disposed between the porous parts to compensate for a position deviation of the non-porous parts of the first and second bearings occurring due to an assembling dispersion between the first and second bearings, to maintain a lubrication property and a stable oil film. The non-porous parts and the porous parts of the first and second bearings have different pore ratio, and the first and second bearings are formed by sintering a bronze series compound.

### CROSS-REFERENCE TO RELATED APPLICATION

This application claims to benefit of Korean Patent Application No. 2000-11939, filed Mar. 10, 2000, in the Korean Intellectual Property Office, the disclosure of which is incorporated herein by reference.

### BACKGROUND OF THE INVENTION

1. Field of the Invention

The present invention relates to a sintered oilless bearing and a motor using the same, and more particularly, to a sintered oilless bearing capable of securing a lubrication property and maintaining a strength of a lubricating oil film, and a capstan motor using first and second bearings supporting a shaft in a radial direction, compensating for a deviation of non-porous parts of the first and second bearings occurring due to an assembling dispersion of the first and second bearings with respect to the shaft, and securing a lubrication property while increasing non-porous parts of the first and second bearings and maintaining a strength of a lubricating oil film when a radial (traverse) pressure is exerted on the first and second bearings.

2. Description of the Related Art

Generally, a capstan motor is used as a uniform-speed feeding unit, which feeds a reproducing and recording medium, such as a tape, to read/storing data from/on the reproducing and recording medium, in an electronic apparatus, such as a video cassette recorder, and has a characteristic maintaining an optimistic feeding speed of the reproducing and recording medium.

As shown in FIG. 1, a conventional capstan motor has a structure similar to a general spindle motor and includes a shaft having an end exposed on an outside of the capstan motor to feed the recording medium, and receiving a radial or traverse pressure (load).

A structure of the capstan motor is further described in conjunction with FIG. 1. The capstan motor includes a shaft 2 and a rotor assembly as a rotor, and a stator assembly as a stator.

The shaft 1 is a rotatable member rotating together with the rotor assembly and includes a first end coupled to a rotor case 4 of the rotor assembly and a second end extended to an outside of the rotor case 4 from the rotor case 4 by a predetermined length. The second end of the shaft 1 extended to the outside of the rotor case 4 contacts a rotating roller, i.e., pinch roller biased against the shaft, through a tape inserted between the shaft 1 and the rotating roller, and the tape is fed to a head disposed in an electronic apparatus according to a rotation of the shaft 1.

The rotor assembly includes the rotor case 4 and a magnet 5 fixedly coupled to an inside surface of the rotor case 4. The rotor case 4 has a cap shape with an opening open to the outside of the rotor case 4, and the magnet 5 is a permanent magnet having N and S poles alternatively arranged around the shaft 1 and is mounted on a portion of the inside surface of the rotor case 4.

The stator assembly includes a base plate having a flat plate shape, a bearing holder 3 having a hollow cylinder shape and disposed in a center portion of the stator assembly corresponding to a center of the shaft 1, and a stator coil 6 disposed on a portion of the base plate to face the magnet 5. The shaft 1 is rotatably inserted into an inside of a bearing 2 disposed in the bearing holder 3 of the base plate, and the stator coil 6 is disposed to face the magnet and to be spaced-apart from the magnet 5 by a predetermined distance to generate a rotation force with the magnet 5, thereby rotating the rotor assembly according to the rotating force.

In the capstan motor having the above structure, since the shaft receives a radial or traverse pressure in a direction with respect to the center of the shaft 1, a plurality of bearings 2 are arranged at a predetermined interval to support the shaft 1.

The bearings 2 are disposed in an inside of the bearing holder 3 at the predetermined interval along the shaft 1. As shown in FIG. 1, a first bearing b1 and a second bearing b2 are forcibly inserted into a lower inside and an upper inside of the bearing holder 3 to be fixedly coupled to the bearing holder 3.

The first and second bearings b1, b2 are used to be ball bearings. However, according to demands requiring a precise control of a motor and a minimization of the electronic apparatus, a sintered oilless bearing is widely used.

The first and second bearings b1, b2 are made of a sintered oilless bearing (sintered bearing) by forming (compacting) a mold with a metallic powder having iron particles, sintering the mold at a non-oxidizing atmosphere with a predetermined temperature, and impregnating the porous sintered mold with oil, i.e., lubricant, in a vacuum state to store the oil with a volume ratio of 15-25% of the porous sintered mold.

In a lubricating operation of the sintered bearing, the oil stored in pores of the sintered bearing is extracted toward an inside surface of the sintered bearing according to a pressure difference occurring due to a rotation of the shaft 1, and the extracted oil forms an oil film between the shaft 1 and the inside surface of the sintered bearing to perform the lubricating operation. When the shaft 1 stops rotating, the oil flows into the pores according to capillary phenomenon to be stored in the pores of the sintered bearing.

The sintered bearing has a hollow cylindrical shape as shown in FIG. 2 and is made by compacting a metallic powder having minute particles with a high pressure in a frame to form the mold, sintering the compacted mold with heat, sizing the sintered mold, and impregnating the sized mold with the oil to store the oil inside the sintered bearing.

An inside diameter of a rotation axle, e.g., the shaft 1, inserted into a hollow cylinder, e.g., the bearing 2, must be maintained within units of m (micrometer). Since severe frictions between the rotation axle and the hollow cylinder occurs due to a side pressure (radial or traverse pressure) exerted on the rotation axle during a rotation of the motor, a very precision is required in processing an inside surface of the rotation axle of the hollow cylinder.

The sintered bearing B of FIG. 2 includes an inside surface having a non-porous part 100 capable of sustaining the radial pressure and a porous part 200 sufficiently supplying the oil to the shaft 1 during the rotation of the shaft 1. The non-porous part 100 and the porous part 200 are disposed at the predetermined interval.

The non-porous part 100 and the porous part 200 are arranged alternatively around the inside surface of the sintered bearing B, and the non-porous part 100 has an angle of 10° to 90° with respect to a center of the sintered bearing B.

In FIGS. 3 through 6 are plain views showing the sintered bearing B. The sintered bearing B of FIG. 3 has nine non-porous parts 100 disposed on the inside surface to have a width corresponding to an angle of 10° with respect to the center of the sintered bearing B and to be spaced-apart from each other by 30°. The sintered bearing B of FIG. 4 has four non-porous parts 100 disposed on the inside surface to have the width corresponding to the angle of 60° and to be spaced-apart from each other by 30°.

The sintered bearing B of FIG. 5 has three non-porous parts 100 disposed on the inside surface to have the width corresponding to the angle of 60° and to be spaced-apart from each other by 60°. The sintered bearing B of FIG. 6 has two non-porous parts 100 disposed on the inside surface to have the width corresponding to the angle of 90° and to be spaced-apart from each other by 30°.

As shown in FIG. 7, the sintered bearings B (b1, b2) are inserted into the bearing holder 3 to be used for a capstan motor.

The bearing holder includes opposite openings formed both sides of a pipe shape, and the first and second sintered bearings b1, b2 are forcibly inserted into corresponding ones of the opposite openings in a direction toward an inside of the bearing holder 3 in a a state that the sintered bearings b1, b2 are disposed at the respective openings of the bearing holder 3.

Although not shown in drawings, the bearing holder 3 is fixedly supported by a stationary frame tool, and the sintered bearings b1, b2 are supported by respective movable tools and moved to be inserted into the inside of the bearing holder 3 according to movements of the movable tools.

However, relative positions of the sintered bearings b1, b2 are deviated during assembling the sintered bearings with the bearing holder 3 if the angle of the non-porous part formed on the sintered bearings b1, b2 is less than 90°.

When the non-porous part 100 of first bearing b1 assembled with an upper portion of the bearing holder 3 should correspond to the non-porous part 100 of second bearing b2 assembled with a lower portion of the bearing holder 3, the shaft 1 is securely supported by the sintered bearings b1, b2 when the radial pressure is exerted on the shaft 1. If the non-porous part 100 is formed to have the angle less than 90°, the relative positions of the non-porous parts 100 of the sintered bearings b1, b2 are deviated from each other.

The relative deviations will be further described in conjunction with FIGS. 7 and 8 which show the deviations between the first and second sintered bearings b1, b2 with respect to the bearing holder 3.

Referring to FIGS. 7 and 8, the sintered bearings b1, b2 are forcibly inserted into the inside of the bearing holder 3 through the opposite openings of the bearing holder 3. Due to different assembling forces exerted on the respective sintered bearings b1, b2 and dimension dispersions of respective parts of the capstan motor, the deviations between the first and second sintered bearings b1, b2 are slightly deviated by a twisted difference (deviation) g.

If the relative deviations of the first and second sintered bearings b1, b2 occur between the first and second sintered bearings b1, b2, the shaft 1 does not contact the non-porous part 100 but comes contact with the porous part 200. Accordingly, contact between the shaft 1 and the porous part 200 causes abrasion of the sintered bearing B and reduces durability since lubrication properties deteriorates, and strength of a bearing supporting force is lowered.

As described above, when angle of the non-porous part is reduced less than 90°, an contacting area between the shaft 1 and the sintered bearing B is increased, and lubrication properties rapidly deteriorate. Accordingly, a friction force between the shaft 1 and the sintered bearing is increased.

When the lubrication properties are reduced, a rotation characteristic of the shaft is lowered, a driving efficiency of the motor is lowered, a life-span of the electronic apparatus is shortened, and reliability of the motor is reduced. If the friction force is increased, it is impossible to smoothly rotate the shaft, a current characteristic of the motor deteriorates. Particularly, the shaft is damaged by iron particles contained in the sintered bearing, thereby lowering an efficiency of the electronic apparatus is lowered.

### SUMMARY OF THE INVENTION

To solve the above and/or other problems, it is an aspect of the invention to provide a bearing capable of providing a lubrication property and maintaining strength of an lubricating oil film, and a motor or capstan motor able to compensating for relative position deviations of non-porous parts occurring due to an assembling dispersion of first and second bearings inserted into a bearing holder and increasing an angle of the non-porous parts with respect to a longitudinal center line of a shaft compared to a conventional non-porous part while providing a lubrication property and maintaining strength of an lubricating oil film.

Additional aspects and advantage of the invention will be set forth in part in the description which follows and, in part, will be obvious from the description, or may be learned by practice of the invention.

To achieve the above and/or other aspects, a capstan motor includes a rotor case having a shaft having a first end coupled to the rotor case and a second end extended from the first end, having a surface on which a magnet is mounted, and having an open end, a base plate covering the open end of the rotor case and having a bearing holder through which the second end of the shaft passes, a stator coil mounted on the base plate to generate a magnetic force with the magnet, a first bearing inserted into a first portion of the bearing holder, having a first inside surface with a first single non-porous part having an angle between 91° and 120° and a first single porous part, and having a pore ratio of the first non-porous part less than 10% according to a formula (the pore ratio=a sum of pore surface areas of a portion/a surface area of the portion), the pore ratio of the first porous part being between 40% and 60% inclusive, the first porous part formed on the first inside surface other than the first non-porous part, and the sintered oilless bearing made of a bronze series compound which is sintered at a sinter temperature, and a second bearing inserted into a second portion of the bearing holder, having a second inside surface with a second single non-porous part having an angle between 91° and 120° and a second single porous part, and having a pore ratio of the second non-porous part is less than 10% according to the formula (the pore ratio=a sum of pore surface areas of a portion/a surface area of the portion), the pore ratio of the second porous part being between 40% and 60% inclusive, the second porous part formed on the second inside surface other than the second non-porous part, and the sintered oilless bearing made of the bronze series compound which is sintered at the sinter temperature.

According to another aspect of the present invention, each of the first and second non-porous parts has a width corresponding to an angle of 100° with respect to a longitudinal center axis of the sintered oilless bearing.

According to another aspect of the present invention, the bronze series compound includes a mixture having a copper powder and a tin powder with a ratio of 90-97% of copper to 3-10% of tin.

According to another aspect of the present invention, the bronze series compound includes a mixture having copper and tin powders having a particle size between 300 mesh and 350 mesh at a ratio of 50 weight % of a total weight of respective ones of the copper and tin powders.

According to another aspect of the present invention, the bronze series compound has the sinter temperature between 720° C. and 760° C. inclusive.

To achieve the above and/or other aspects, a capstan motor includes a rotor case having a shaft having a first end coupled to the rotor case and a second end extended from the first end, having a surface on which a magnet is mounted, and having an open end, a base plate covering the open end and having a bearing holder through which the second end of the shaft passes, a stator coil mounted on the base plate to generate a magnetic force with the magnet, a first bearing inserted into a first portion of the bearing holder, having a first inside surface with a plurality of first non-porous parts having an angle between 91° and 120° and a plurality of first porous parts which are formed to be arranged alternatively around the first inside surface, and having a pore ratio of the first non-porous parts less than 10% according to a formula (the pore ratio=a sum of pore surface areas of a portion/a surface area of the portion), the pore ratio of the first porous parts being between 40% and 60% inclusive, the first porous parts formed on the first inside surface other than the first non-porous parts, and the sintered oilless bearing made of a bronze series compound which is sintered at a sinter temperature, and a second bearing inserted into a second portion of the bearing holder, having a second inside surface with a plurality of second non-porous parts having an angle between 91° and 120° and a plurality of second porous parts which are formed to be arranged alternatively around the second inside surface, and having a pore ratio of the second non-porous parts less than 10% according to the formula (the pore ratio=a sum of pore surface areas of a portion/a surface area of the portion), the pore ratio of the second porous parts between 40% and 60% inclusive, the second porous parts formed on the second inside surface other than the second non-porous part, and the sintered oilless bearing made of the bronze series compound which is sintered at the sinter temperature.

According to another aspect of the present invention, each of the first and second non-porous parts has a width corresponding to an angle of 100° with respect to a longitudinal center axis of the sintered oilless bearing, and the first and second-porous parts are disposed on two portions of corresponding ones of the first and second inside surfaces at an interval of 180°.

According to another aspect of the present invention, each of the first and second non-porous parts has a width corresponding to an angle of 100° with respect to a longitudinal center axis of the sintered oilless bearing, and the first and second porous parts are disposed on a remaining portion of corresponding ones of the first and second inside surfaces on which corresponding ones of the first and second non-porous parts are not formed.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 is a cross-sectional view of a conventional capstan motor;

FIG. 2 is a perspective view of a sintered oilless bearing of the conventional capstan motor shown in FIG. 1;

FIGS. 3 through 6 are views showing the sintered oilless bearing shown in FIG. 2;

FIG. 7 is a view showing a process of assembling the sintered oilless bearing into a bearing holder shown in FIGS. 1 and 2;

FIG. 8 is a partially sectional view showing the sintered oilless bearing assembled with the bearing holder shown in FIG. 7.

FIG. 9 is a cross-sectional view of a sintered oilless bearing used in a capstan motor according to an embodiment of the present invention;

FIG. 10 is a perspective view of the sintered oilless bearing shown in FIG. 9;

FIG. 11 is a cross-sectional view of a sintered oilless bearing according to another embodiment of the present invention;

FIG. 12 is a perspective view of the sintered oilless bearing shown in FIG. 11;

FIG. 13 is a view showing an angle of a non-porous part of the sintered oilless bearing shown in FIGS. 9 and 11;

FIG. 14 is a view showing current changes and the angle of the non-porous part of the sintered oilless bearing;

FIG. 15 is a view showing a load current and a motor rotation speed (RPM) in a conventional sinter-containing and the sintered oilless bearing according to the present invention; and

FIGS. 16 and 17 are views showing a current according to angle deviations of the non-porous parts of first and second sintered oilless bearings in the capstan motor.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by reference to the figures.

Hereinafter, a capstan motor having a sintered oilless bearing (sintered bearing) is described in conjunction with the drawings. The capstan motor is described as an example. However, the present invention is not limited thereto. The sintered oilless bearing constructed according to the present invention can be used in other type motors than the capstan motor.

In the capstan motor, an non-porous part of the sintered oilless bearing is formed on an inside surface of the sintered oilless bearing at predetermined interval, and an angle of the non-porous part of the sintered oilless bearing with respect to a longitudinal center line of the sintered oilless bearing or the shaft, which receives a radial or traverse pressure (load), is increased. The sintered oilless bearing is made of a bronze series compound (compound having bronze particles or bronze-containing compound). A pore ratio of the non-porous part and a porous part is limited or adjusted. A position deviation of the non-porous parts contacting lower and upper portions of the shaft, respectively, is compensated while strength of a lubricating oil film is maintained in a state that the radial or traverse pressure (side load) is exerted on the shaft.

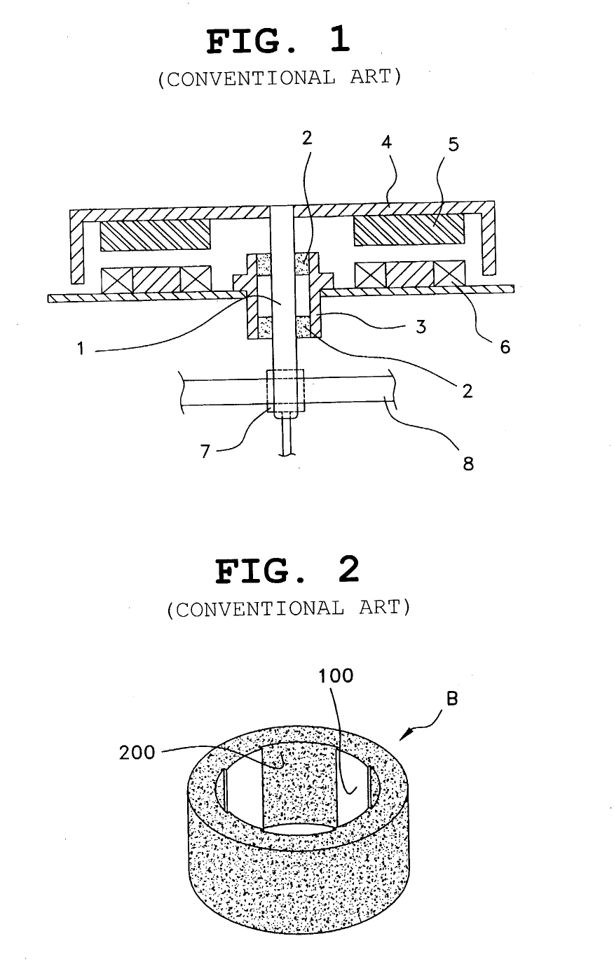

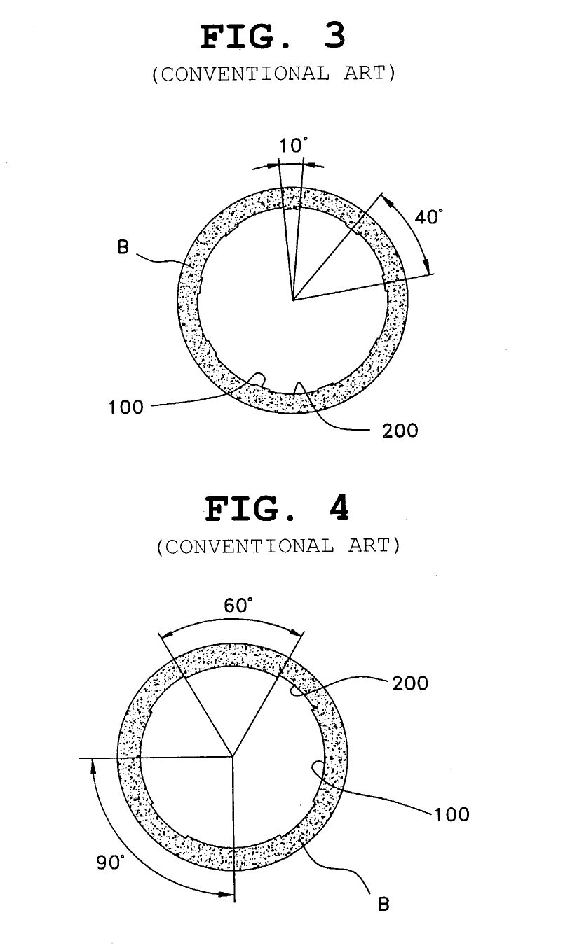

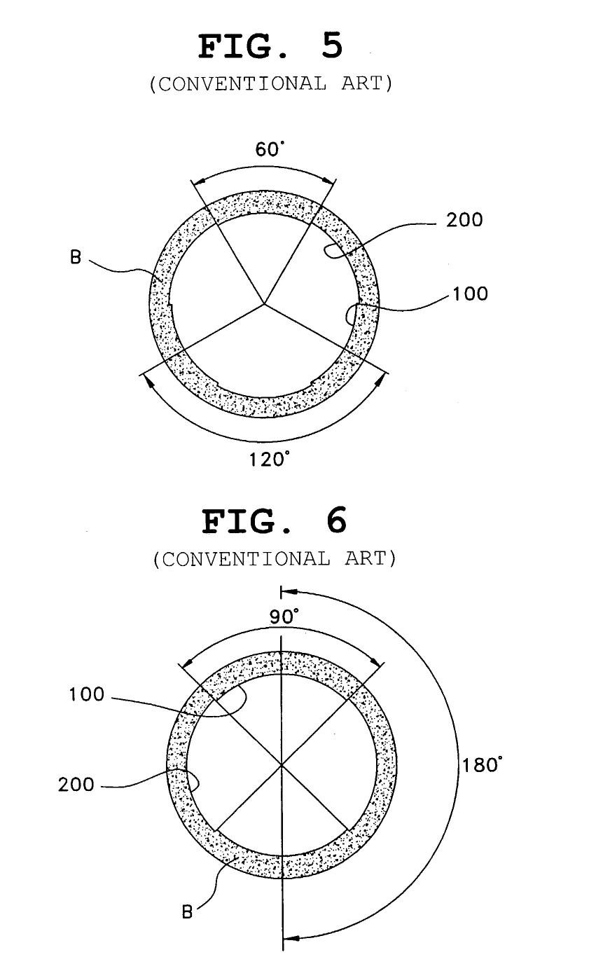

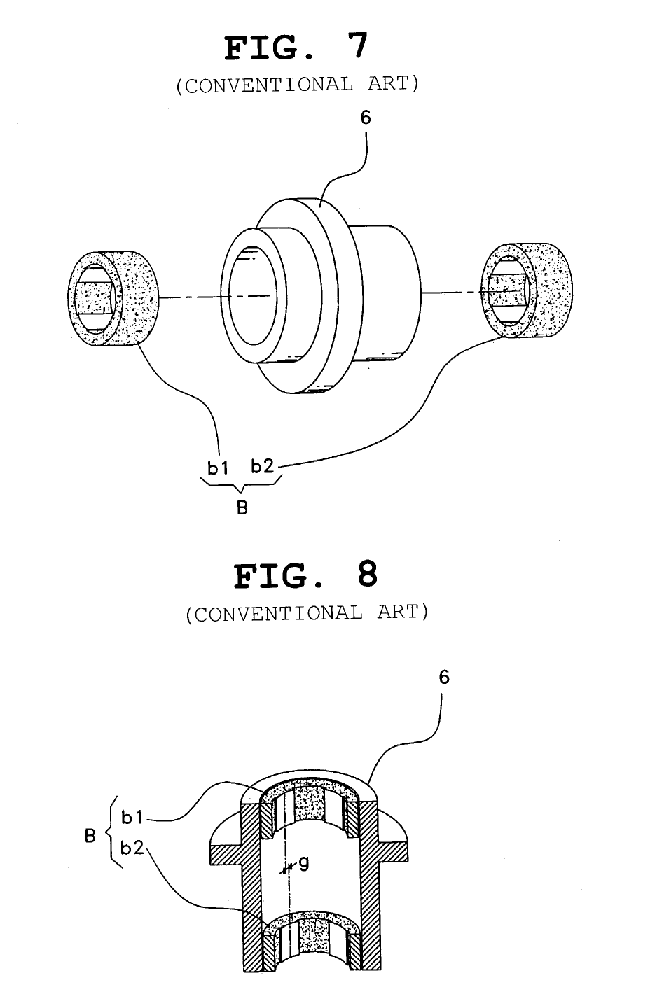

The capstan motor according to the present invention is explained with reference to FIG. 1 and includes a rotor case 4, a shaft 1 coupled to a center of the rotor case 4, a magnet 5 mounted on an inside portion of the rotor case 4, a base plate provided to cover an open end of the rotor case 4, a bearing holder 3 mounted on a center of the base plate to receive the shaft 1, and a stator coil 6 mounted on the base plate to generate a rotation force with the magnet 5. A circuit printed board having a circuit driving the stator may be mounted on the base plate.

First and second bearings b1, b2, e.g., sintered oilless bearing (sintered bearing) B, are forcibly inserted into upper and lower insides of the bearing holder 3, respectively, to be spaced-apart from each other at a predetermined interval. The shaft 1 is rotatably inserted into the first and second bearings b1, b2.

On an inside surface of the first and second bearings b1, b2, a non-porous part 10 supporting the shaft 1 and a porous part 20 forming a lubrication oil film are alternatively arranged with respect to a circular direction of a longitudinal axis of the first and second bearings b1, b2.

In the capstan motor provided with the first and second bearings b1, b2 made of the sintered bearing, the first and second bearings b1, b2 is formed from a sinter to increase an angle of the non-porous part 10 to 91°-120° from the angle of 10°-90° of a conventional sintered bearing to compensate for an angle deviation between the non-porous parts of the first and second bearings b1, b2. The first and second bearings b1, b2 are formed with the sinter having the bronze series compound to stably maintain a side oil film of the shaft 1 while increasing a surface of the non-porous part. The non-porous part 10 and the porous part 20 have different pore ratio from each other.

First, hereinafter, a technical characteristic of the angle of the non-porous part 10 of the sintered bearing of the capstan motor is described.

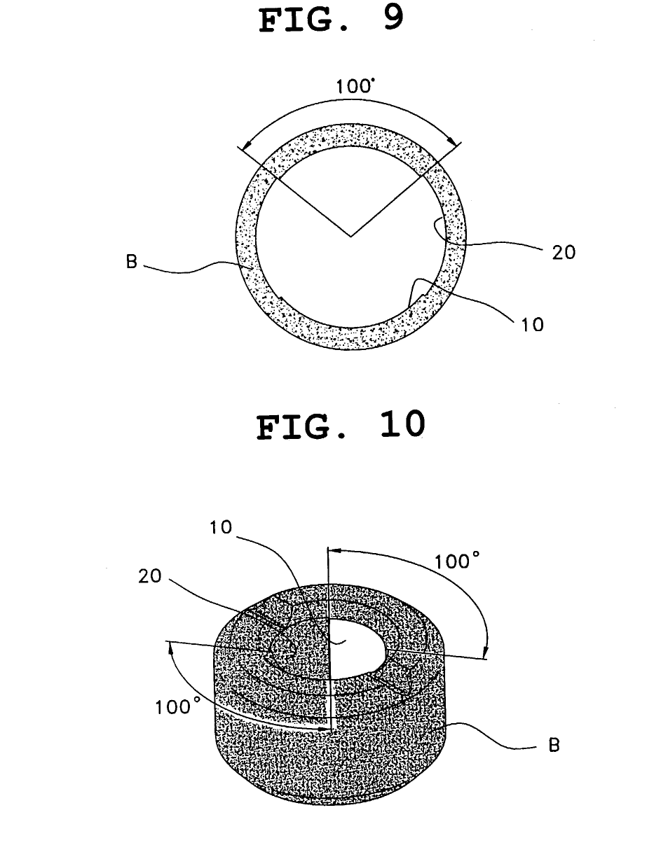

FIGS. 9 and 10 shows the sintered bearing B according to an embodiment of the present invention. A structure of the sintered bearing B will be described with reference to FIG. 1, and like reference numerals refer to the like elements.

As shown in FIGS. 9 and 10, the non-porous part 10 is formed on the inside surface of the sintered bearing B to have about 100° greater than 90° and is formed on two opposite portions of the inside surface to face each other.

Since the non-porous parts 10 formed on two portions of the inside surface has the angle greater than 90°, the angle of the porous part 20 becomes less than 90°.

If the angle of the non-porous part 10 is increased to at least 91°, the angle of the porous part 20 is decreased less than 89°. Therefore, the sintered bearing B is a structure in which the angle of the non-porous part 10 is increased, and the angle of the porous part 20 is decreased according to the increased angle of the non-porous part 10.

If the angle of the non-porous part 10 is increased excessively, the angle of the porous part 20 is decreased relative to the excessive increase of the angle of the non-porous part 10, thereby reducing a lubricating operation. Therefore, it is desirable that the angle of the non-porous part 10 is about 100° as shown in FIG. 9.

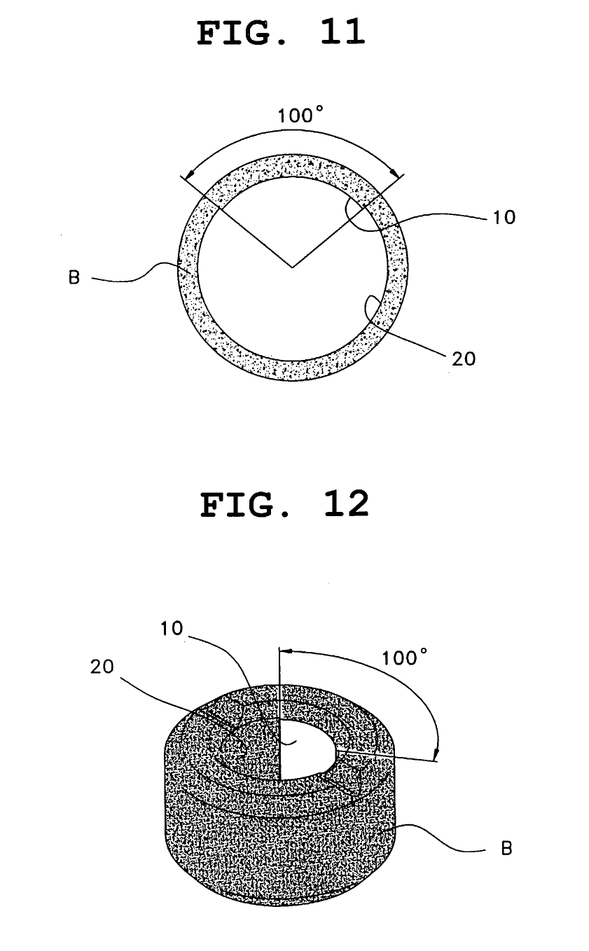

FIGS. 11 and 12 show the sintered bearing B according to another embodiment of the present invention. Another structure of the sintered bearing B will be described with reference to FIG. 1, and like reference numerals refer to the like elements.

The non-porous part 10 is formed on only one single portion of the inside surface of the sintered bearing B. That is, the non-porous part 10 is formed on the inside surface of the sintered bearing B to have the angle of about 100° greater than 90° while a remaining portion of the inside surface of the sintered bearing B is formed with the porous part 20. Since the porous part 20 is widely formed on the inside surface of the sintered bearing except for the single portion corresponding to the non-porous part 10, the lubrication property is increased a great deal compared to the conventional sintered bearing.

When the non-porous part 10 is formed on the single portion of the inside surface of the sintered bearing B, there is enough space to form the non-porous part 10, and it is possible to expand the angle of the non-porous part 10 to 120°.

As described above, since the non-porous part 10 of the sintered bearing B receiving the radial pressure (side load) from the shaft can be formed to have a width corresponding to the angle widened more than 90°, it is possible to compensate for a relative position deviation between the non-porous parts 10 of the first and second bearing b1, b2 which are disposed on the lower and upper portion of the bearing holder 3, respectively.

That is, when the relative position deviation occurs during assembling the first and second bearings into the bearing holder 3, a portion supporting the shaft 1 can be the non-porous part 10 by expanding the width of the non-porous part 10 in the inside surface of the first and second bearing b1, b2.

If the non-porous part 10 of the sintered bearing B is formed to have the angle greater than 90°, and the non-porous part 10 is formed on the two opposite facing portions of the inside surface of the sintered bearing B as shown in FIG. 9, it is possible to distinguish the non-porous part 10 from the porous part 20 since the angle of the non-porous part 10 is greater than the angle of the porous part 20 disposed between the non-porous parts 10.

Moreover, when the non-porous part 10 is formed on the single portion of the inside surface of the sintered bearing B as shown in FIG. 11, it becomes very convenient to find a location of the non-porous part 10 in the sintered bearing B, and the position deviation between the non-porous parts 10 can be minimized in assembling the first and second bearings b1, b2.

Accordingly, when the sintered bearing B of FIG. 9 is assembled into the capstan motor, and the non-porous parts 10 of the first and second bearings b1, b2 are disposed to be arranged to face the same direction and in corresponding directions at opposite openings of the bearing holder 3 to be inserted into a precise position of the bearing holder 3, the first and second bearings b1, b2 can be accurately assembled into the bearing holder.

When the non-porous part 10 of the sintered bearing B is formed on the single portion or two portions of the inside surface of the sintered bearing B, and the sintered bearing B is processed after sintered, an amount of work for the processing of the sintered bearing B is reduced compared to in a number of non-porous parts of the conventional sintered bearing, thereby reducing a processing time of the sintered bearing B.

Particularly, when the non-porous part 10 is formed on the single portion of the inside surface of the sintered bearing B to have a minimum angle greater than 90°, an area of the non-porous part 10 is expanded compared to the area of the porous part 20, thereby providing a more efficient lubricating property.

Since the angle of 120° is a maximum angle to compensate for the angle deviation of the non-porous parts 19 due to the assembling dispersion between the first and second bearings b1, b2, it is desirable to form the non-porous part 10 having the angle between 91° and 120°.

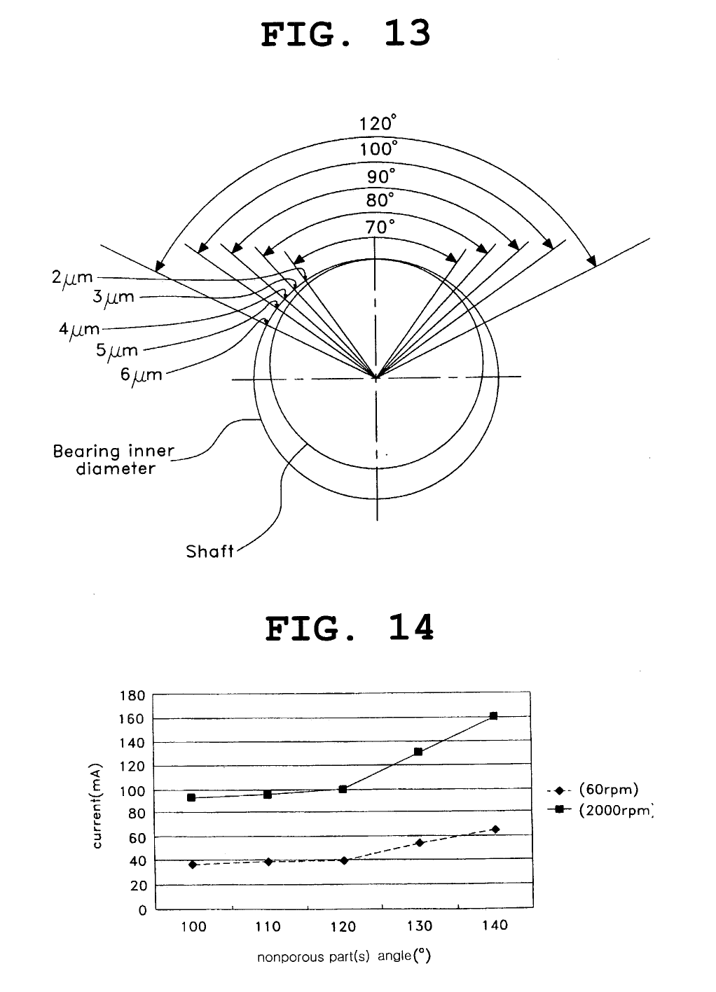

FIG. 13 is a view showing the angle of the non-porous part 10. Referring to FIG. 13, angles of the non-porous part 10 of the sintered bearing B are 70°, 80°, 90°, 100°, 120°, and clearances between the shaft 1 and the inside surface of the sintered bearing B at one end of the non-porous part 10 are 2 μm, 3 μm, 4 μm, 5 μm, and 7 μm at one end of the non-porous part 10 according to the respectively angles of the non-porous part 10.

Generally, a dimension of the sintered bearing (sintered oilless bearing) B is variable according to a formation method and characteristics and density of a material during formation of the sintered bearing B, and it is difficult to improve or maintain a true-circle degree of the inside surface, e.g., equal radii with respect to the longitudinal center line of the sintered bearing B.

When the true-circle degree of the inside surface of the sintered bearing B is minimum 2 μm, the shaft 1 does not affect the non-porous part 10 when the clearance is disposed at a center portion of the non-porous part 10 of the sintered bearing B in a case that the angle of the non-porous part 10 is 70°.

This indicates that abrasion occurs between the shaft 1 and the sintered bearing B when the a portion of the shaft 1 is disposed on the non-porous part 10 of the inside surface of the sintered bearing B in a case that the relative positions of the first and second bearings are deviated by even a very small amount during assembling the first and second bearings with the bearing holder 3. In this case, it is not achieved that the shaft 1 should be disposed on the non-porous part 10, and a motor characteristic is badly effected.

When the true-circle degree of the inside surface of the sintered bearing B is minimum 2 μm in a case of 90° of the angle of the non-porous part 10, the shaft 1 affects the non-porous part 10 if the first and second bearings are deviated from each other by 5° in different (left and right) directions although there is a 2 μm clearance.

If the first and second bearings are deviated by 5° in the different directions, the shaft 1 affects the non-porous part 10.

Since the first and second bearings can be generally deviated by 5° in consideration of precision degrees of assembling equipment and the sintered bearing B, if the angle of the non-porous part 10 is widened, it is possible to remove or minimize a concern about the position deviation of the first and second bearings. However, if the angle of the non-porous part 10 is greater than 120°, the lubricating operation of the oil film is badly affected. Thus, it is possible to maintain a characteristic value of the oil film effectively if the angle of the non-porous part 10 is less than 120°.

Second, a technical characteristic of a lubrication property of the sintered bearing in the capstan motor is explained hereinafter.

The first and second bearings b1, b2 are made by sintering the bronze series compound to prevent a deterioration of the lubrication property by providing the widened angle of the non-porous part 10 compared with the non-porous part of the conventional sintered bearing to compensate for the relative angle deviation of the non-porous parts 10 of the first and second bearings b1, b2.

That is, as described above, the first and second bearings b1, b2 is formed by sintering the bronze series compound to provide the lubrication property to reduce a friction occurring due to an increase of a friction surface between the shaft 1 and the non-porous part 10 of the sintered bearing B having the angle between 91° and 120°.

A general sintered oilless bearing is formed by sintering a compound having iron particles with a high hardness, and the general sintered oilless bearing having the iron particles causes the abrasion and damage on contact surfaces of the shaft 1 due to a friction force occurring when the shaft 1 contacts the general sintered oilless bearing having the iron particles. As a result, the lubrication property deteriorates, a current flowing through the non-porous part 10 is increased, and a rotation property of the shaft 1 is reduced.

To the contrary, since the bronze series compound has ductility and abrasion-proof and erosion-proof properties compared to the general sintered oilless bearing having the iron particles, the sintered bearing B sintered with the bronze series compound can reduce the abrasion of the contact surfaces of the shaft 1 due to the friction force occurring when the shaft 1 contacts the sintered oilless bearing B having bronze series compound particles. In addition, the lubrication property becomes excellent, the current flowing through the non-porous part 10 is lowered, and the rotation property of the shaft 1 is increased.

Accordingly, the sintered bearing B is formed by sintering the bronze series compound according to an aspect of the invention. The bronze series compound includes 90-97 weight % of copper (Cu), 3-10 wight % of tin (Sn) and is sintered at a predetermined temperature. In the bronze series compound, copper and tin particle powders having a particle size 300-350 mesh are mixed by a 50 weight % ratio.

Here, it is possible to set a sintering temperature to sinter the bronze series compound to about 450° as a pre-heating temperature and about 720°-760° as a main-heating temperature. It is also possible to use a furnace for bronze in sintering the bronze series compound to prevent foreign materials from being introduced into the sintered bearing B having the bronze series compound.

Third, a technical characteristic of the sintered bearing B to maintain the oil film stable in the capstan motor with respect to a side load (radial pressure) is explained hereinafter.

The sintered bearing B able to be used in the capstan motor has different pore ratios of the non-porous part 10 supporting the shaft 10 and the porous part 20 forming the lubricating oil to prevent the deterioration of the oil film caused by the widened angle of the non-porous part 10 compared to the conventional non-porous part and to promote a circulation of the oil while maintaining the strength of the oil film.

That is, in forming the non-porous part 10 providing the oil film and the porous part 20 promoting the oil circulation, the pore ratio of the non-porous part 10 is less than about 10%, and the pore ratio of the porous part 20 is about 40-60%.

The pore ratio is expressed by the following formula. pore ratio (%)=(a sum of pore surface areas of a product)/(surface area of the product)

When viscosity of the oil stored in the sintered bearing is too low, the current may be lowered, but a high temperature property is badly affected. To the contrary, the viscosity is too high, an initial current becomes increased, thereby causing a load on the motor. Accordingly, it is possible to use the oil having the viscosity of 150 cst-190 cst to maximize the efficiency of the motor.

FIG. 14 is a view showing load current changes according to the angle of the non-porous part 10 of the sintered oilless bearing B sintered with the bronze series compound and having the above technical characteristic.

As shown in FIG. 14, a solid line indicates a first current variation according to the angle of the non-porous part 10 in a state that a rotation speed of the motor is 2000 RPM, and a broken line indicates a second current variation according to the angle of the non-porous part 10 in a state that the rotation speed of the motor is 60 RPM.

FIG. 14 shows a stable current characteristic when the angle of the non-porous part 10 is between 91°-120°. However, from the angle of the non-porous part 10 greater than 120°, the current increases a great deal in both cases of 60 RPM and 2000 RPM in the rotation speed of the motor. This is because the lubrication operation is not properly performed due to a decrease of a surface area of the porous part 20 according to an increase of the surface area of the non-porous part 10. In particular, the current increases and varies unstably with a very unstable amplitude due to a more increase of the friction force at a high speed than at a lower speed.

Therefore, it is necessary to maintain the angle of the non-porous part 10 within 120° while solving the problems occurring in assembling the sintered bearing B having the angle of the non-porous part less than 90° with the capstan motor.

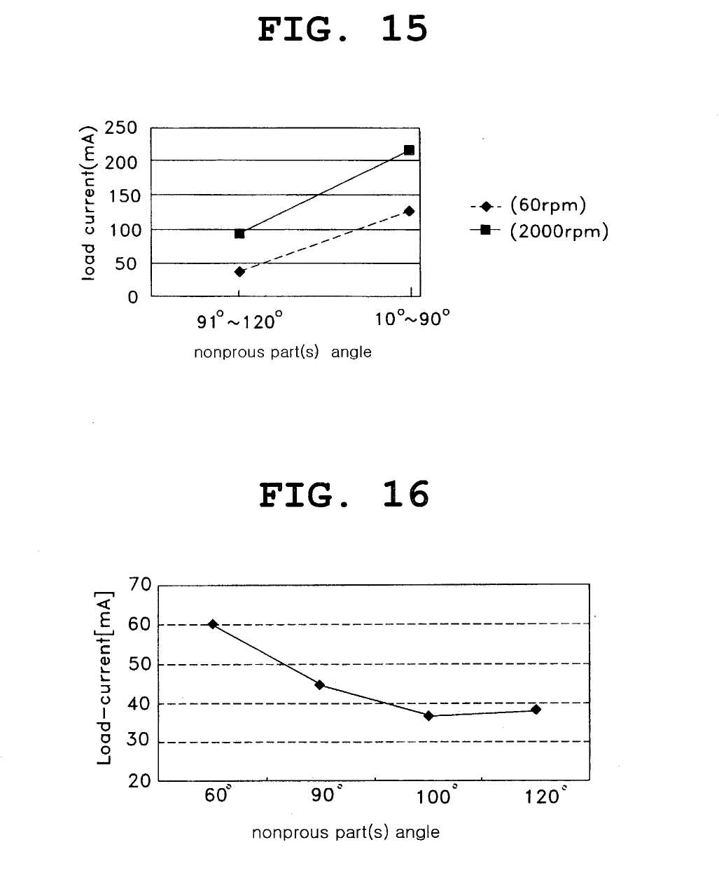

FIG. 15 is a view showing the load current flowing through the sintered oilless bearing which is formed with the non-porous part 10 having the angle between 910-120° according to the present invention in a case that a predetermined side load (radial or traverse pressure) is exerted on the shaft 10.

As shown in FIG. 15, a load current characteristic of the present invention is compared with a conventional load current characteristic of the conventional sintered bearing having the angle of the non-porous part less than 90°.

TABLE 1

| | | | When the angle of |
|---|---|---|---|
| | | When the angle of | the non-porous |
| | | the non-porous | part is from 10° |
| | | part is 91°-120° | less than 90° |
| 1) | When the side load is | 37.6 | 127 |
| | 1.2 kgf, | | |
| | a. the current (mA) when | | |
| | the rotation speed is | | |
| | 60 RPM | | |
| | b. the current (mA) when | 93.9 | 215 |
| | the rotation speed is | | |
| | 2000 RPM | | |
| 2) | When the side load is re- | 83 | 93 |
| | moved, the current | | |

As shown in table 1 and FIG. 15, when the sintered bearing B is formed with the bronze series compound, and the angle of the non-porous part 10 is 91°-120°, the lead current is 37.6 mA in a case that the side load is 1.2 kgf and the motor rotation speed is 60 RPM, and 93.9 mA in a case that the side load is 1.2 kgf and the motor rotation speed is 2000 RPM.

In contrast, when the conventional sintered bearing is formed with the compound having iron particles, and the angle of the non-porous part is less than 90°, the lead current is 127 mA in the case that the side load is 1.2 kgf and the motor rotation speed is 60 RPM, and 215 mA in the case that the side load is 1.2 kgf and the motor rotation speed is 2000 RPM.

When the side load is not exerted on the shaft 1, the load current of the present invention is 8.0 mA while the load current of the conventional sintered bearing is 93 mA.

That is, since the sintered bearing B is formed by sintering the bronze series compound, has the angle of the non-porous part 10 between 91°-120°, the lubrication property and the friction characteristic are improved a great deal, and the load current is reduced compared with the conventional sintered bearing having the angle of the non-porous part less than 90°.

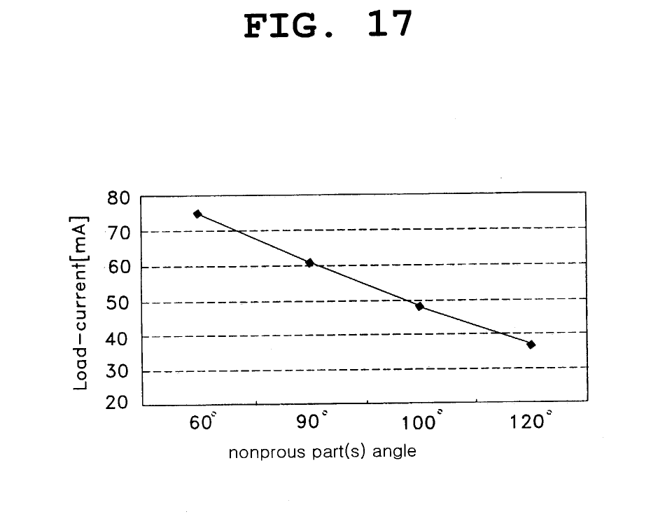

FIG. 16 is a graph showing a side load current variation when the relative position deviation of the non-porous parts 10 of the first and second bearings b1, b2 of the sintered bearing is 5°, and FIG. 17 is a graph showing a side load current variation when the relative position deviation of the non-porous parts 10 of the first and second bearings b1, b2 of the sintered bearing is 10°. A side load current of FIGS. 16 and 17 is 60 mA.

Referring to FIG. 16, when the relative position deviation of the non-porous parts 10 of the first and second bearings b1, b2 of the sintered bearing is 5°, the side load current is 60 mA in a case that the angle of the non-porous part is 60°, 45 mA in a case that the angle of the non-porous part is 90°, 36 mA in a case that the angle of the non-porous part is 100°, and 38 mA in a case that the angle of the non-porous part is 120°.

Referring to FIG. 17, when the relative position deviation of the non-porous parts 10 of the first and second bearings b1, b2 of the sintered bearing is 10°, the side load current is 75 mA in a case that the angle of the non-porous part is 60°, 62 mA in a case that the angle of the non-porous part is 90°, 48 mA in a case that the angle of the non-porous part is 100°, and 37 mA in a case that the angle of the non-porous part is 120°.

As shown in FIGS. 16 and 17, when the relative position deviation of the non-porous parts 10 of the first and second bearings b1, b2 of the sintered bearing is 5° or 10°, the current with respect to the angle of the non-porous part 10 is increased according to the decrease of the angle of the non-porous part 10.

In addition, the current characteristic deteriorates due to the position deviation between the non-porous parts 10 of the first and second bearings b1, b2.

An optimized current characteristic can be obtained when the sintered bearing B has the different pore ratio of the non-porous part 10 and the porous part 20 from each other, is formed by sintering the bronze series compound, and has the angle of the non-porous parts 10 of the first and second bearings b2, b2 between 91°-120°.

As described above, the position deviation of the non-porous parts 10 of the first and second bearings b1, b2 assembled with the lower and upper portion of the bearing holder 3 can be compensated when the sintered bearing B is formed with the non-porous parts 10 of the first and second bearings b2, b2 having the angle between 91°-120°.

Even if the relative position of the non-porous parts 10 of the first and second bearings b1, b2 during assembling the first and second bearings b1, b2 with the bearing holder 3 is deviated, the shaft 1 continues to come to contact with the non-porous parts 10 of the first and second bearings b1, b2 by forming the non-porous part 10 having the widened angle compared with the conventional non-porous part.

Since the sintered bearing B is formed with the bronze series compound, the deterioration of the lubrication property can be prevented by widening the angle of the non-porous part 10, and the strength of the lubricating oil film can be stably maintained during occurring the side load exerted on the shaft rotatably inserted into the first and second bearings b1, b2 by forming the non-porous part 10 and the porous part 20 having the different pore ratio.

Accordingly, the sintered bearing constructed according to the present invention is very effective in providing a smooth motor driving characteristic of the motor and improving reliability of the motor a great deal.

Although a few preferred embodiments of the present invention have been shown and described, it would be appreciated by those skilled in the art that changes may be made in this embodiment without departing from the principle and sprit of the invention, the scope of which is defined in the claims and their equivalent.

What is claimed is:

1. A sintered oilless bearing having an inside surface, comprising:
a single non-porous part; and
a single porous part,
wherein the single non-porous part and the porous part are formed on the inside surface, a pore ratio of the non-porous part is less than 10% according to a formula (the pore ratio=a sum of pore surface areas of a portion/a surface area of the portion), the pore ration of the porous part is between 40% and 60% inclusive, the porous part is formed on the inside surface other than the non-porous part, and the sintered oilless bearing is made of a bronze series compound which is sintered at a sinter temperature.

2. The bearing of claim 1, wherein the non-porous part has a width corresponding to an angle between 91° and 120° inclusive with respect to a longitudinal center axis of the sintered oilless bearing.

3. The bearing of claim 1, wherein the non-porous part has a width corresponding to an angle of 100° with respect to a longitudinal center axis of the sintered oilless bearing.

4. The bearing of claim 1, wherein the bronze series compound comprises:
a mixture having a copper powder and a tin powder with a ratio of 90-97% of copper to 3-10% of tin.

5. The bearing of claim 1, wherein the bronze series compound comprises:
a mixture having copper and tin powders having a particle size between 300 mesh and 350 mesh at a ratio of 50 weight % of a total weight of respective ones of the copper and tin powders.

6. The bearing of claim 1, wherein the bronze series compound has the sinter temperature between 720° C. and 760° C. inclusive.

7. A sintered oilless bearing having an inside surface, comprising:
a plurality of non-porous parts; and
a plurality of porous parts, wherein the non-porous parts and the porous parts are alternatively formed on the inside surface, a pore ratio of the non-porous part is less than 10% according to a formula (the pore ratio=a sum of pore surface areas of a portion/a surface area of the portion), the pore ratio of the porous part is between 40% and 60% inclusive, the porous part is formed on the inside surface other than the non-porous part, and the sintered oilless bearing is made of a bronze series compound which is sintered at a sinter temperature.

8. The bearing of claim 7, wherein each non-porous part has a width corresponding to an angle between 91° and 120° inclusive with respect to a longitudinal center axis of the sintered oilless bearing.

9. The bearing of claim 7, wherein the bronze series compound comprises:
a mixture having a copper powder and a tin powder with a ratio of 90-97% of copper to 3-10% of tin.

10. The bearing of claim 7, wherein the bronze series compound comprises:
a mixture having copper and tin powders having a particle size between 300 mesh and 350 mesh at a ratio of 50 weight % of a total weight of respective ones of the copper and tin powders.

11. The bearing of claim 1, wherein the bronze series compound has the sinter temperature between 720° C. and 760° C. inclusive.

12. The bearing of claim 1, wherein each non-porous part has a width corresponding to an angle of 100° with respect to a longitudinal center axis of the sintered oilless bearing, and the non-porous parts are disposed on two portions of the inside surface at an interval of 180°.

13. The bearing of claim 1, wherein each non-porous part has a width corresponding to an angle of 100° with respect to a longitudinal center axis of the sintered oilless bearing, and the porous parts are disposed on a remaining portion of the inside surface on which the non-porous parts are not formed.

14. A capstan motor comprising:
a rotor case having a shaft having a first end coupled to the rotor case and a second end extended from the first end, having a surface on which a magnet is mounted, and having an open end;
a base plate covering the open end, and having a bearing holder through which the second end of the shaft passes;
a stator coil mounted on the base plate to generate a magnetic force with the magnet;
a first bearing inserted into a first portion of the bearing holder, having a first inside surface with a first single non-porous part and a first single porous part, and having a pore ratio of the first non-porous part is less than 10% according to a formula (the pore ratio=a sum of pore surface areas of a portion/a surface area of the portion), the pore ratio of the first porous part being between 40% and 60% inclusive, the first porous part formed on the first inside surface other than the first non-porous part, and the sintered oilless bearing made of a bronze series compound which is sintered at a sinter temperature; and
a second bearing inserted into a second portion of the bearing holder, having a second inside surface with a second single non-porous part and a second single porous part, and having a pore ratio of the second non-porous part less than 10% according to the formula (the pore ratio=a sum of pore surface areas of a portion/a surface area of the portion), the pore ratio of the second porous part being between 40% and 60% inclusive, the second porous part formed on the second inside surface other than the second non-porous part, and the sintered oilless bearing made of the bronze series compound which is sintered at the sinter temperature.

15. The bearing of claim 14, wherein each of the first and second non-porous parts has a width corresponding to an angle between 91° and 120° inclusive with respect to a longitudinal center axis of the sintered oilless bearing.

16. The bearing of claim 14, wherein each of the first and second non-porous parts has a width corresponding to an angle of 100° with respect to a longitudinal center axis of the sintered oilless bearing.

17. The bearing of claim 14, wherein the bronze series compound comprises:
a mixture having a copper powder and a tin powder with a ratio of 90-97% of copper to 3-10% of tin.

18. The bearing of claim 14, wherein the bronze series compound comprises:
a mixture having copper and tin powders having a particle size between 300 mesh and 350 mesh at a ratio of 50 weight % of a total weight of respective ones of the copper and tin powders.

19. The bearing of claim 14, wherein the bronze series compound has the sinter temperature between 720° C. and 760° C. inclusive.

20. A capstan motor comprising:
a rotor case having a shaft having a first end coupled to the rotor case and a second end extended from the first end, having a surface on which a magnet is mounted, and having an open end;
a base plate covering the open end, and having a bearing holder through which the second end of the shaft passes;
a stator coil mounted on the base plate to generate a magnetic force with the magnet;
a first bearing inserted into a first portion of the bearing holder, having a first inside surface with a plurality of first non-porous parts and a plurality of first porous parts which are formed to be arranged alternatively around the first inside surface, and having pore ratio of the first non-porous parts less than 10% according to a formula (the pore ratio=a sum of pore surface areas of a portion/a surface area of the portion), the pore ratio of the first porous parts is between 40% and 60% inclusive, the first porous parts formed on the first inside surface other than the first non-porous parts, and the sintered oilless bearing made of a bronze series compound which is sintered at a sinter temperature; and
a second bearing inserted into a second portion of the bearing holder, having a second inside surface with a plurality of second non-porous parts and a plurality of second porous parts which are formed to be arranged alternatively around the second inside surface, and having a pore ratio of the second non-porous parts less than 10% according to the formula (the pore ratio=a sum of pore surface areas of a portion/a surface area of the portion), the pore ratio of the second porous parts between 40% and 60% inclusive, the second porous parts formed on the second inside surface other than the second non-porous part, and the sintered oilless bearing made of the bronze series compound which is sintered at the sinter temperature.

21. The bearing of claim 20, wherein each of the first and second non-porous parts has a width corresponding to an angle between 91° and 120° inclusive with respect to a longitudinal center axis of the sintered oilless bearing.

22. The bearing of claim 20, wherein the bronze series compound comprises:
a mixture having a copper powder and a tin powder with a ratio of 90-97% of copper to 3-10% of tin.

23. The bearing of claim 20, wherein the bronze series compound comprises:
a mixture having copper and tin powders having a particle size between 300 mesh and 350 mesh at a ratio of 50 weight % of a total weight of respective ones of the copper and tin powders.

24. The bearing of claim 20, wherein the bronze series compound has the-sinter temperature between 720° C. and 760° C. inclusive.

25. The bearing of claim 20, wherein each of the first and second non-porous parts has a width corresponding to an angle of 100° with respect to a longitudinal center axis of the sintered oilless bearing, and the first and second-porous parts are disposed on two portions of corresponding ones of the first and second inside surfaces at an interval of 180°.

26. The bearing of claim 20, wherein each of the first and second non-porous parts has a width corresponding to an angle of 100° with respect to a longitudinal center axis of the sintered oilless bearing, and the first and second porous parts are disposed on a remaining portion of corresponding ones of the first and second inside surfaces on which corresponding ones of the first and second non-porous parts are not formed.
